(19) United States
(12) Patent Application Publication
(10) Pub. No.: US 2012/0165224 A1
(43) Pub. Date: Jun. 28, 2012

(54) CELL CHIP

(75) Inventors: Suk Ho SONG, Gyunggi-do (KR); Bo Sung Ku, Gyunggi-do (KR); Se Hoon Jeong, Seoul (KR); Moo Yeal Lee, Burlingame, CA (US); Dong Woo Lee, Gyunggi-do (KR)

(73) Assignee: SAMSUNG ELECTRO-MECHANICS CO., LTD.

(21) Appl. No.: 13/335,182

(22) Filed: Dec. 22, 2011

(30) Foreign Application Priority Data
Dec. 22, 2010 (KR) 10-2010-0132859

(51) Int. Cl. C40B 40/00

(52) U.S. Cl. 506/13

(57) ABSTRACT

Disclosed herein is a cell chip including: an upper substrate having a plurality of biometrics spaced therefrom by fillers, the biometrics fixing a biomaterial thereinto; a first hydrophobic coating layer formed on the upper substrate; and a lower substrate combined with the upper substrate and having a plurality of wells formed therein, the well storing fluid provided to the biometrics therein. The cell chip includes two substrates functionally separated from each other to implement a three dimensional cell chip, solves a cross contamination problem, and provides a similar environment to a bio environment, thereby making it possible to increase the accuracy of a test.

### CROSS REFERENCE TO RELATED APPLICATION

This application claims the benefit of Korean Patent Application No. 10-2010-0132859, filed on Dec. 22, 2010, entitled “Cell Chip”, which is hereby incorporated by reference in its entirety into this application.

### BACKGROUND OF THE INVENTION

1. Technical Field

The present invention relates to a cell chip.

2. Description of the Related Art

A process of developing a new reagent (or drug) is configured of complicated steps, and cell culture is necessarily required in order to test the effect and toxicity of a reagent candidate material. Generally, a cell culture method may be mainly divided into a scheme (two dimension (2D) cell monolayer culture scheme) of adhering and culturing cells to a 2D surface and a scheme (three dimensional (3D) cell culture) of fixing and culturing cells into a 3D biometrics.

As an example of a 2D cell chip, there may be a microtiter plate (e.g., a 6-well microtiter plate, a 12-well microtiter plate, a 24-well microtiter plate, a 96-well microtiter plate, a 384-well microtiter plate, a 1536-well microtiter plate, etc.,) in which a plurality wells are arranged on a plate. In order to culture cells in the well of the microtiter plate, about several Mls to several tens μls of a culture medium is required. The microtiter plate can rapidly perform several tests simply at low cost, as compared to animal/human clinical trials.

However, the microtiter plate has a shape in which the cell is fixed into the well, thereby having a difficulty in performing the cleaning for removing the cell after processing the reagent. This problem is significantly intensified in the case in which a size of the well is reduced and the number thereof is increased in order to perform more tests in a single plate, such as the 384-well microtiter plate or the 1536-well microtiter plate.

In order to solve this problem and perform a test in a smaller volume, an array based cell chip in which cells three dimensionally fixed onto a flat glass substrate are cultured has been developed by Solidus Biosciences Inc. In the array based cell chip, the well is not formed, and the cells are fixed onto the glass substrate using collagen or alginate.

In the array based cell chip, a biometrics fixing the cell therein is attached onto the flat glass substrate. Therefore, the array based cell chip may be more easily cleaned and more rapidly perform a toxicity test of the reagent, as compared to an existing microtiter plate.

However, since the array based cell chip is implemented on the flat substrate, such that adjacent biometrics are not physically shielded from each other, it is more likely to lead to test errors due to cross contamination and since a very small amount of reagent are evaporated by being exposed to the air, it is not proper to observe cells for a long period of time (for example, a day or more) even though high humidity is maintained.

### SUMMARY OF THE INVENTION

The present invention has been made in an effort to provide a three dimensional cell chip including a lower substrate storing a culture medium and a reagent supplied to biomaterials therein and an upper substrate combined with the lower substrate and having biometrics formed to protrude therefrom, the biometrics fixing the biomaterials thereinto.

Further, the present invention has been made in an effort to provide a cell chip capable of preventing cross contamination due to mixing of a culture medium and a reagent even though a plurality of wells are formed in a lower substrate, being easily cleaned, and testing influence by the reagent while culturing biomaterials for a long period of time.

Further, the present invention has been made in an effort to provide a cell chip capable of solving a bubble problem in storing a culture medium and a reagent and being used for a long period of time without twist.

According to a preferred embodiment of the present invention, there is provided a cell chip including: an upper substrate having a plurality of biometrics spaced therefrom by fillers, the biometrics fixing a biomaterial thereinto; a first hydrophobic coating layer formed on the upper substrate; and a lower substrate combined with the upper substrate and having a plurality of wells formed therein, the well storing fluid provided to the biometrics therein.

The filler may be formed on a lower surface of the upper substrate, and the first hydrophobic coating layer may cover the entire lower surface of the upper substrate.

The first hydrophobic coating layer may be extended to cover a side of the filler.

The cell chip may further include a second hydrophobic coating layer or a hydrophilic coating layer formed on an inner wall of the well.

The cell chip may further include a third hydrophobic coating layer formed on an upper surface of the lower substrate and separating adjacent wells from each other.

The biometrics may have an array arrangement, and the well may have the same arrangement as that of the biometrics.

The biometrics may be made of extracellular matrix or hydrogel.

The cell chip may further include an adhesive layer disposed between the filler and the biometrics.

The biometrics may be inserted into the well so as to be immersed in the fluid.

The upper substrate may further include a plurality of through holes formed from one surface thereof to the other surface thereof.

The through hole may have a circular or polygonal cross section.

The through hole may be formed adjacent to an outer side of a bonding surface between the filler and the upper substrate.

The through hole may be positioned on a surface vertical to the well.

### BRIEF DESCRIPTION OF THE DRAWINGS

FIG. 1 is an exploded perspective view schematically showing a cell chip according to a first preferred embodiment of the present invention;

FIG. 2 is a cross-sectional view showing a separated state of the cell chip shown in FIG. 1;

FIG. 3 is a cross-sectional view showing a combined state of the cell chip shown in FIG. 1;

FIG. 4A is an enlarged cross-sectional view of the cell chip shown in FIG. 1; and FIGS. 4B to 4D are enlarged cross-sectional views showing modified examples thereof;

FIG. 5 is a cross-sectional view schematically showing a cell chip according to a second preferred embodiment of the present invention; and

FIG. 6 is a cross-sectional view showing a modified example of the cell chip shown in FIG. 5.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

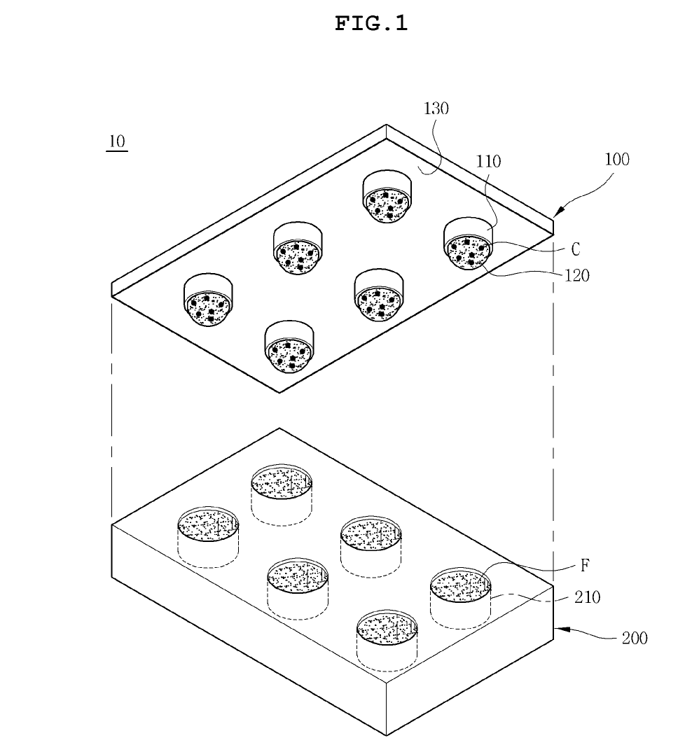

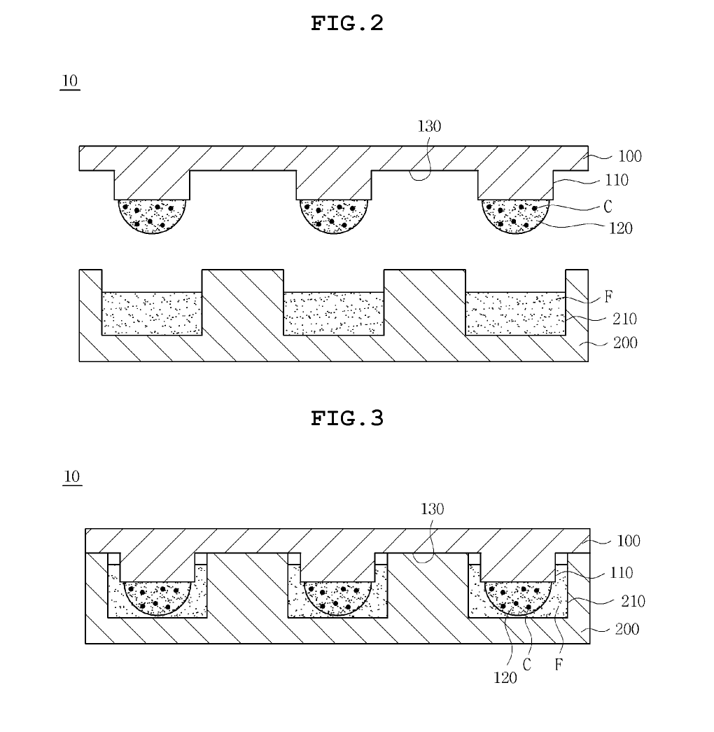

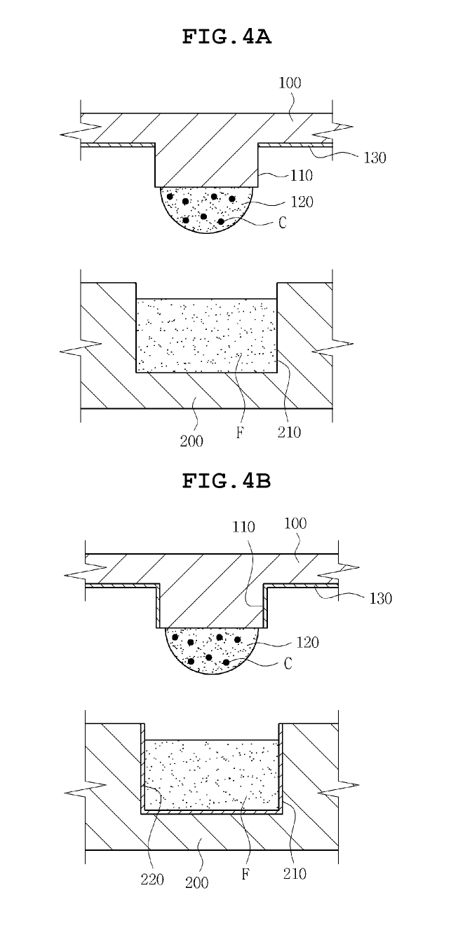

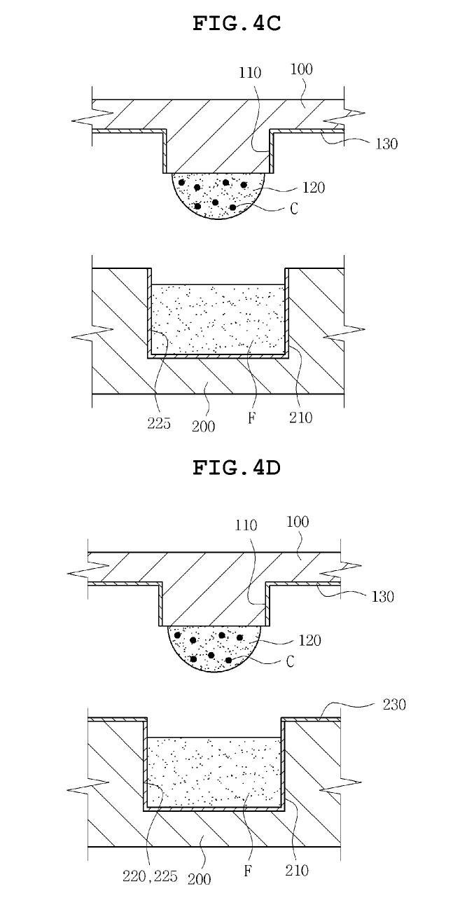

FIG. 1 is an exploded perspective view schematically showing a cell chip according to a first preferred embodiment of the present invention; FIG. 2 is a cross-sectional view showing a separated state of the cell chip shown in FIG. 1; FIG. 3 is a cross-sectional view showing a combined state of the cell chip shown in FIG. 1. In addition, FIG. 4A is an enlarged cross-sectional view of the cell chip shown in FIG. 1; and FIGS. 4B to 4D are enlarged cross-sectional views showing modified examples thereof. A cell chip according the present embodiment will be described with reference to the accompanying drawings.

As shown in FIG. 1, a cell chip 10 is configured to include an upper substrate 100 having biometrics 120 formed to be spaced therefrom, the biometrics fixing the biomaterials C thereinto; and a lower substrate 200 supplying a culture medium or a reagent (the culture medium and the reagent are simultaneously supplied, and hereinafter, the medium, the reagent, or the like, supplied to biomaterials C will be referred to as fluid F) to the biomaterials C.

The term “biomaterial” includes various biomolecules. An example of the biomolecules may include a nucleic acid arrangement (for example, DNA, RNA, oligo nucleotide, cDNA, extranuclear plasmid, or the like), peptid, protein, fatty, protein or lipid film, organic or inorganic chemical molecule (for example, compound of pharmaceuticals or other fields), virus particles, eukaryotic cell or prokaryotic cell, blast cell component or organelle, or the like.

In this configuration, the fluid F supplied through the lower substrate 200 may include as a dyed material (for example, a fluorescent material and a luminescent material), protein, plasmid, DNA, interference RNA, antigen/antibody, virus, or the like, as well as a reagent and a culture medium necessary for specific tests in order to provide an environment more similar to a bio environment to the biomaterial C.

First, the upper substrate 100 will be described. As the upper substrate, a glass substrate, a plastic substrate, a ceramic substrate, or the like, may be used. In addition, the upper substrate 100 may have any shape and thickness.

In addition, the upper substrate 100 includes a plurality of fillers 110 formed in order to dispose the biometrics 120 so as to be spaced from a surface of the upper substrate 100.

The filler 110 serves to space the biometrics 120 from the surface of the upper substrate 100 to thereby facilitate the cleaning of the cell chip. The filler 110 having a protruding shape is sufficient to perform the above-mentioned function; however, it preferably has a pillar shape such as a circular cylinder shape or a polyprism shape in order to provide adhesive surfaces on which the biometrics 120 are to be formed.

The fillers 110 may be formed integrally with the upper substrate 100 during a process of forming the upper substrate 100 or be formed by attaching a separate member to the upper substrate 100 using an adhesive.

The fillers 110 have the biometrics 120 formed thereon, wherein the biometrics fixes the biomaterials C thereinto. Since the upper substrate 100 is disposed upwardly of the lower substrate 200 and the biometrics 120 are inserted into wells 210, the fillers 110 are disposed on a lower surface of the upper substrate 100. Therefore, the biometrics 120 are also disposed on the lower surface of the upper substrate 100.

The biometrics 120 may be made of a sol-gel, an inorganic material, an organic polymer, or an organic-inorganic complex material capable of fixing the biomaterial thereinto. In particular, the biometrics 120 is preferably made of extracellular matrix such as collagen having a porous structure and moving through diffusion of fluid or hydrogel such as alginate without being toxic to a biomaterial.

The biometrics 120 provides an environment similar to a bio environment to the biomaterial C or provides an environment appropriate for specific tests by supplying test fluid or fluid in the well 210 to the biomaterial C through diffusion.

The biometrics 120 fixing the biomaterial C thereinto are formed by being spotted to the filler 110 in the state in which the biomaterial C and the biometrics 120 are mixed or may be formed by first spotting the biometrics 120 and then the biomaterial C thereon. Particularly, when the biometrics 120 are formed by being spotted to the upper substrate 100 in the state in which the biomaterial C and the biometrics 120 are mixed, the biomaterial C is embedded and fixed into the biometrics 120.

In addition, the upper substrate 100 having the fillers 110 formed thereon is stamped on a container in which the biomaterial C and the biometrics 120 are mixed, thereby making it possible to accomplish the above-mentioned object.

The cell chip 10 according to the present embodiment includes a plurality of unit cell chips (the unit cell chip indicates a state in which a single filler 110 having the biometrics 120 formed thereon is inserted into the well 210). The unit cell chips preferably have an array arrangement in order to be more easily classified and compared. The array arrangement of the unit cell chips is accomplished by forming the biometrics 120 in an array arrangement and forming the wells 210 corresponding to the array arrangement of the biometrics. Meanwhile, although FIG. 1 shows a case in which the unit cell chips has a 2×3 arrangement, it is only an example. The number of unit cell chips may be changed.

In addition, an adhesive layer (not shown) may be further formed on a contact surface between the filler 110 and the biometrics 120 in order to increase an adhesive force between the filler 110 and the biometrics 120. The adhesive layer may be formed by applying an adhesive to one surface of the filler 110 and then spotting the biometrics 120 mixed with the biomaterial C.

For example, when alginate is used as the biometrics 130, the adhesive layer is preferably made of a mixture of poly-L-lysine (PLL) and barium chloride.

The lower substrate 200 will be described. As the lower substrate, a glass substrate, a plastic substrate, a ceramic substrate, or the like, may be used. In addition, the lower substrate 200 may preferably have a shape corresponding to that of the upper substrate 100 and any thickness.

As shown in FIGS. 2 and 3, the lower substrate 200 has the wells 210 formed therein, wherein the well 210 stores fluid F therein. When the upper substrate 100 is combined with the lower substrate 200, the biometrics 120 is inserted into the well 210 having the fluid stored therein.

The shape of the well 210 is not limited. However, it is preferable that the well 210 has an area larger than that of the biometrics 120 so that the above-mentioned biometrics 120 may be inserted thereinto and also has a depth larger than a height of the biometrics 120. Particularly, it is more preferable that the well 210 has a depth so that both of the filler 110 and the biometrics 120 may be inserted thereinto.

It is preferable that when the biometrics 120 is inserted into the well 210, the biometrics 120 is disposed to be immersed in the fluid F in order to be supplied with a sufficient amount of fluid F. This may be accomplished by a method of controlling the amount of fluid F or controlling a height of the filler 110.

Functions of the upper substrate 100 and the lower substrate 200 are separated from each other as described above, thereby making it possible to solve a cleaning problem of the microtiter plate according to the prior art and also solve a cross contamination problem or a drying problem in the array based cell chip according to the prior art. That is, since the biomaterials C are not directly positioned in the wells 210 storing the fluid therein, residues may not remain in the wells 210 unlike the microtiter plate according to the prior art, and the lower substrate 200 may also be reused after cleaning. In addition, the wells 210 may supply different fluids F to each of the biometrics 120 in a spatially separated state, thereby making it possible to solve the cross contamination problem, and the upper substrate 100 serves as a cover, thereby making it possible to solve the drying problem.

Meanwhile, when the upper substrate 100 and the lower substrate 200 are combined with each other, they may be combined so as to be in contact with each other as shown in FIG. 3 or be combined so as to be spaced from each other (by a method of forming a protruding member between the upper and lower substrates, etc.) in order to supply air therebetween. In this case, a spacing distance between the upper substrate 100 and the lower substrate 200 may be changed in a range in which the biometrics 120 is inserted into the well 210.

The cell chip 10 according to the present invention includes a first hydrophobic coating layer 130 formed on the upper substrate 100 in order to prevent cross contamination generated due to movement of condensed moisture or evaporated fluid F to an adjacent well 210 through the upper substrate 100.

As shown in FIG. 3, the cell chip in the state in which the upper substrate 100 and the lower substrate 200 are combined with each other is used in a high-temperature/high-humidity culture chamber. In this case, the moisture is condensed inside the culture chamber to be introduced into the well 210 or the fluid F is evaporated inside the culture chamber to be moved to the adjacent well 210 through the upper substrate 100, thereby making it possible to cause the cross contamination. This cross contamination problem may be intensified in the case in which the substrate is made of a hydrophilic material capable of being easily bonded to the moisture.

According to the present invention, the first hydrophobic coating layer 130 is formed on the upper substrate 100 to thereby prevent a phenomenon that the moisture in the culture chamber is condensed on the chip. In addition, the above-mentioned first hydrophobic coating layer 130 is preferably formed on a surface of the upper substrate 100 except for a surface of the filler 110 having the biometrics 120 positioned thereon. When the filler 110 is formed on a lower surface of the upper substrate 100 as shown in FIG. 4A, the first hydrophobic coating layer 130 preferably covers the entire lower surface of the upper substrate 100.

After a region in which the above-mentioned first hydrophobic coating layer 130 is not formed, that is, a contact surface between the filler 110 and the biometrics 120 is protected by laminating a film thereon, a molecular vapor deposition (MVD) process, a physical vapor deposition (PVD) process, a chemical vapor deposition (CVD) process, or the like is performed to thereby form the first hydrophobic coating layer 130.

In the case of using a plasma processing process, the upper substrate having the film laminated thereon is disposed in a plasma reactor, CF₄ gas is injected thereinto to form plasma gas, and the plasma gas is deposited on the upper substrate. As the injected gas, fluorine based gas in addition to CF₄ or carbon based gas such as CH₄, etc., may be used.

It is more preferable that the first hydrophobic coating layer 130 is formed on the lower surface of the upper substrate 100 and is extended to cover a side of the filler 110, as shown in FIG. 4B. When the filler 110 is inserted into the well 210, there may be a fine space between the filler 110 and the well 210. As a result, the fluid F may rise through this space due to a capillary phenomenon, thereby making it possible to cause cross contamination. As shown in FIG. 4B, when the first hydrophobic coating layer 130 is formed on the side of the filler 110, the capillary phenomenon is suppressed, thereby making it possible to prevent cross contamination.

Further, it is more preferable that the cell chip 10 according to the present invention includes a second hydrophobic coating layer 220 formed on an inner wall of the well 210, as shown in FIG. 4B. When the fluid F is filled in the well 210, a swelling phenomenon in which the inner wall of the well 210 absorbs the fluid F to be swelled may be generated. The second hydrophobic coating layer 220 prevents the inner wall of the well 210 from absorbing the fluid F, thereby making it possible to previously prevent the swelling phenomenon.

The second hydrophobic coating layer 220 may be formed by a method similar to a method of forming the first hydrophobic coating layer 130. A region except for the well 210 is covered by laminating a film thereon, and a molecular vapor deposition (MVD) process, a physical vapor deposition (PVD) process, a chemical vapor deposition (CVD) process, a plasma process, or the like, is performed to thereby form the second hydrophobic coating layer 220 on the inner wall of the well 210. Alternatively, after the second hydrophobic coating layer 220 is formed over the lower substrate 200 by performing the above-mentioned MVD process, the PVD process, the CVD process, or the like, the second hydrophobic coating layer 220 deposited on the region except for the well 210 of the lower substrate 200 may be removed by performing a chemical-mechanical polishing (CMP) process, etc.

However, the cell chip 10 according to the present invention should not necessarily include the second hydrophobic coating layer 220 formed on the inner wall of the well 210; however, it may also include a hydrophilic coating layer 225 formed on the inner wall of the well 210, as shown in FIG. 4C. When the fluid F is filled in the well 210, it collides with the inner wall of the well 210, such that bubbles may be generated. The hydrophilic coating layer 225 serves to improve affinity between the fluid F and the well 210, thereby preventing the bubbles from being generated. Meanwhile, the hydrophilic coating layer 225 may be formed by a method similar to the above-mentioned method of forming the first hydrophobic coating layer 130. However, in the case of using the plasma process, the method of forming the hydrophilic coating layer 225 is similar to the method of forming the first hydrophobic coating layer 130; however, it is partially different therefrom in that gas such as carbon dioxide, argon, nitrogen, oxygen, hydrogen, helium, or the like is filled in the plasma reactor.

It is more preferable that the cell chip 10 according to the present invention further includes a third hydrophobic coating layer 230 formed on an upper surface of the lower substrate 200, as shown in FIG. 4D. The third hydrophobic coating layer 230 serves to prevent the movement of the fluid F generated through the lower substrate 200. That is, the third hydrophobic coating layer 230 may be formed on the upper surface of the lower substrate 200 and the second hydrophobic coating layer 220 or the hydrophilic coating layer 225 may be formed on the inner wall of the well 210.

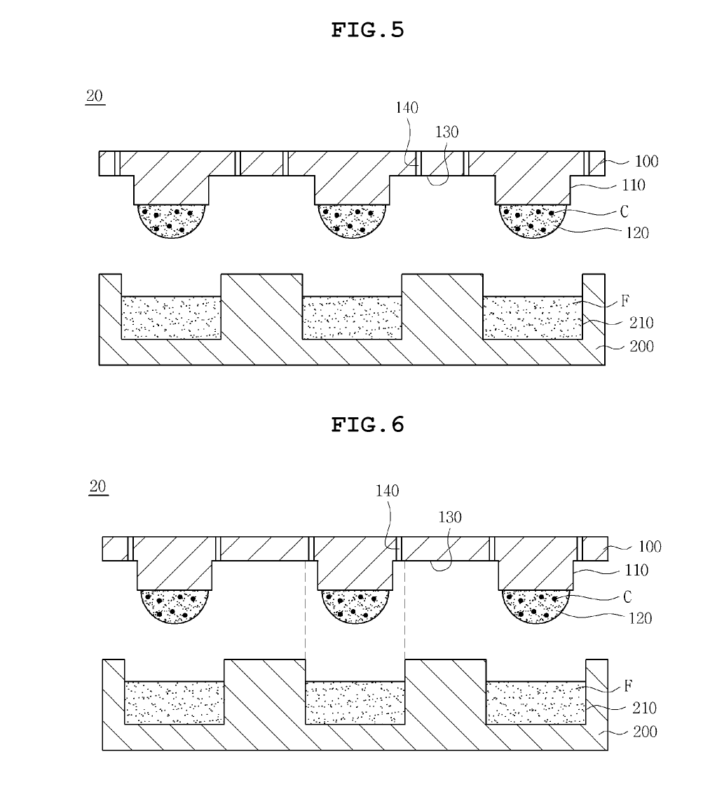

FIG. 5 is a cross-sectional view schematically showing a cell chip according to a second preferred embodiment of the present invention; and FIG. 6 is a cross-sectional view showing a modified example of the cell chip shown in FIG. 5.

The cell chip 20 according to the present embodiment has a plurality of through holes 140 formed from one surface of the upper substrate 100 to the other surface thereof as well as the first hydrophobic coating layer 130 formed on the upper substrate 100. The through hole 140 reduces warp generated in the upper substrate and provides a moving path for bubbles and air.

The through hole 140 may have a cross-section having various shapes such as a circular shape or a polygonal shape, and the cross-sectional area and the number of through holes 140 may be changed as needed.

The through hole will be described in detail with reference to FIGS. 5 and 6. As shown in FIG. 5, the through hole 140 may be formed in a space between the fillers 110. The warp is continuously generated from one side of the upper substrate 100 to the other side thereof, such that the mismatching between the upper substrate 100 and the lower substrate 200 may be generated. The through-holes 140 discontinue the continuously generated warp to thereby reduce warp of the upper substrate 100. The through-holes 140 are preferably repetitively formed at predetermined intervals in a transversal direction or a longitudinal direction in order to increase an effect of the warp discontinuity.

The through-holes 140 serve as a moving path for bubbles generated by the reaction between the biomaterial C and the reagent and exterior air. Since the bubbles are generated around the biometrics 120 formed on the filler 110, the plurality of through holes 140 are preferably formed adjacent to a bonding surface between the filler 110 and the upper substrate 100 in order to rapidly remove the bubbles, and more preferably enclose the bonding surface of the filler 110 and the upper substrate 100.

Due to the same reason as described above, the through holes 140 are preferably positioned on a surface vertical to the well 210 formed in the lower substrate 200. The bubbles may be easily removed and the air may also be more easily introduced, through the above-mentioned structure.

With the cell chip according to the preferred embodiments of the present invention, when the effect and toxicity mechanism of the reagent is tested, the biomaterial is fixed into the biometrics to be supplied with the culture medium and the reagent through diffusion, and is supplied with several appropriately changed reagents (for example, tests are performed while changing the biomaterial to be appropriate for specific objects through gene transfection or RNA interference (RNAi)), thereby making it possible to provide an environment similar to a human body or an animal. Therefore, accurate and predictable data may be secured. Ultimately, the cell chip according to the preferred embodiments of the present invention may replace a complicated and expensive human body/animal clinical trial.

In addition, according to the preferred embodiments of the present invention, the lower substrate supplying the culture medium and the reagent and the upper substrate formed with the biometrics fixing the biomaterial thereinto are functionally separated from each other, thereby making it possible to easily clean the cell chip.

Further, according to the preferred embodiments of the present invention, the upper substrate includes the first hydrophobic coating layer, and the lower substrate includes the second hydrophobic coating layer, thereby making it possible to solve cross contamination problem that the culture mediums or the reagents are mixed between adjacent wells.

Furthermore, according to the preferred embodiments of the present invention, the hydrophilic coating layer is formed in the well, thereby making it possible to solve the bubble problem generated when the culture medium and the reagent are stored, and the through hole is formed in the upper substrate to provide the moving path for the bubbles and the air, thereby making it possible to reduce the warp generated in the upper substrate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A cell chip comprising:
an upper substrate having a plurality of biometrics spaced therefrom by fillers, the biometrics fixing a biomaterial thereinto;
a first hydrophobic coating layer formed on the upper substrate; and
a lower substrate combined with the upper substrate and having a plurality of wells formed therein, the well storing fluid provided to the biometrics therein.

2. The cell chip as set forth in claim 1, wherein the filler is formed on a lower surface of the upper substrate, and the first hydrophobic coating layer covers the entire lower surface of the upper substrate.

3. The cell chip as set forth in claim 1, wherein the first hydrophobic coating layer is extended to cover a side of the filler.

4. The cell chip as set forth in claim 1, further comprising a second hydrophobic coating layer or a hydrophilic coating layer formed on an inner wall of the well.

5. The cell chip as set forth in claim 1, further comprising a third hydrophobic coating layer formed on an upper surface of the lower substrate and separating adjacent wells from each other.

6. The cell chip as set forth in claim 1, wherein the biometrics has an array arrangement, and the well has the same arrangement as that of the biometrics.

7. The cell chip as set forth in claim 1, wherein the biometrics is made of extracellular matrix or hydrogel.

8. The cell chip as set forth in claim 1, further comprising an adhesive layer disposed between the filler and the biometrics.

9. The cell chip as set forth in claim 1, wherein the biometrics is inserted into the well so as to be immersed in the fluid.

10. The cell chip as set forth in claim 1, wherein the upper substrate further includes a plurality of through holes formed from one surface thereof to the other surface thereof.

11. The cell chip as set forth in claim 10, wherein the through hole has a circular or polygonal cross section.

12. The cell chip as set forth in claim 10, wherein the through hole is formed adjacent to an outer side of a bonding surface between the filler and the upper substrate.

13. The cell chip as set forth in claim 10, wherein the through hole is positioned on a surface vertical to the well.
